(19) United States
(12) Patent Application Publication
(10) Pub. No.: US 2026/0036942 A1
(43) Pub. Date: Feb. 5, 2026

(54) ANIMATION MECHANISM

(71) Applicant: RICHEMONT INTERNATIONAL SA, Villars-sur-Glâne (CH)

(72) Inventor: Martin CRETEGNY, Genève (CH)

(21) Appl. No.: 18/995,342

(22) PCT Filed: Jul. 27, 2023
(86) PCT No.: PCT/IB2023/057615

§ 371 Date: Jan. 16, 2025

(30) Foreign Application Priority Data
Aug. 24, 2022 (CH) 000989/2022

(51) Int. Cl. G04B 45/00; F16H 37/12; G04B 25/06; G04B 47/04

(52) U.S. Cl. CPC G04B 45/0038; F16H 37/124; G04B 25/06; G04B 47/044

(57) ABSTRACT

Animation mechanism (1) comprising a cam (2) mounted to move in rotation about an axis of rotation of the cam (2), the cam (2) comprising a guide groove (22) arranged around the axis of rotation of the cam (2), a first animation member (35) kinematically connected to the cam (2) by a first transmission member (3), a second animation member (36) kinematically connected to the cam (2) by a second transmission member (4), the first transmission member (3) and the second transmission member (4) each comprising a cam follower member inserted in the guide groove (22). Timepiece (10) comprising such an animation mechanism (1).

The present invention relates to an animation mechanism making it possible to animate one or a plurality of animation members forming one or a plurality of objects (people, figures, animals, etc.) and/or indicating time information. The present invention relates in particular to an animation mechanism intended to be used in a timepiece.

Numerous animation mechanisms are known and make it possible to cause one or a plurality of people, figures, animals or time information displays to move in order to obtain an entertaining effect. This movement is generally a cyclical movement: starting from an initial position, the one or more animation members move into a specific sequence of positions before returning to their initial position. These mechanisms are particularly used in jewellery or horology. In general, when they are integrated into a movement of a timepiece, they are arranged to trigger the animation at specific moments (for example upon the hour) or when requested via a control member which the user can actuate.

An animation mechanism is generally associated with a drive member which transmits to the animation mechanism the power required to make the animation member or members move. In the case where the animation mechanism is associated with a timepiece movement, the drive member of the animation mechanism can be either the drive member of the movement or a distinct drive member dedicated solely to the animation mechanism.

The integration of an animation mechanism in a timepiece, in particular in a wristwatch, is often difficult owing to the size and complexity of the mechanism, in particular when a plurality of animation members are moving or when there are multiple displacements of the animation members during a cycle.

An aim of the present invention is to propose an animation mechanism making it possible to animate a plurality of animation members with less complexity and thus reduced space requirement compared with the prior art mechanisms.

This aim and other advantages are achieved in particular by means of an animation mechanism comprising a cam mounted to move in rotation about an axis of rotation of the cam, the cam comprising a guide groove arranged around the axis of rotation of the cam, a first animation member kinematically connected to the cam by a first transmission member, a second animation member kinematically connected to the cam by a second transmission member, the first transmission member and the second transmission member each comprising a cam follower member inserted in the guide groove.

The use of a single cam with a single guide groove to move at least two transmission members which animate at least two animation members makes it possible to reduce the number of moving parts to a minimum. Furthermore, the use of a guide groove in which the cam follower members of the transmission members are inserted makes it possible to precisely guide the transmission members in all their degrees of freedom without requiring a return mechanism such as a spring or the like to return them in one direction.

The second animation member is preferably kinematically connected to the first animation member. Thus, the simultaneous or successive displacement of the first and second transmission members makes it possible to produce animations comprising relatively complex movements of one animation member with respect to the other using the single cam.

The second animation member is for example mounted to move in rotation with respect to the first animation member.

The animation mechanism of the invention comprises for example a first carriage and a first arm mounted to move in rotation on the first carriage, the first carriage being kinematically connected to the first transmission member and the first arm being kinematically connected to the second transmission member, the first animation member being fixed on the first carriage and the second animation member being fixed on the first arm.

The first carriage is for example mounted to move in translation.

It is thus possible to configure the mechanism so that the first and the second animation members move together in translation under the action of the first transmission member and so that the second animation member pivots with respect to the first animation member under the action of the second transmission member, the first and the second transmission members both being activated by the same cam.

The guide groove preferably forms a closed curve, which allows the cam always to be turned in the same direction.

According to one embodiment, the first transmission member is a lever mounted to move in rotation and the second transmission member is a bar mounted to move in translation.

The guide groove comprises for example at least one active portion, in which the distance from the guide groove to the axis of rotation of the cam is variable, and at least one inactive portion, in which the distance from the guide groove to the axis of rotation of the cam is constant, the animation mechanism being configured so that when the cam follower member of the first transmission member follows an active portion of the guide groove, the cam follower member of the second transmission member follows an inactive portion of the guide groove, and so that when the cam follower member of the second transmission member follows an active portion of the guide groove, the cam follower member of the first transmission member follows an inactive portion of the guide groove.

According to certain embodiments, the animation mechanism further comprises a third animation member, a fourth animation member and a third transmission member, the third animation member being kinematically connected to the cam by the third transmission member, and the fourth animation member being connected to the cam by the second transmission member, the third transmission member comprising a cam follower member inserted in the guide groove.

The animation mechanism is thus for example configured so that, when the cam follower member of the first transmission member follows an active portion of the guide groove, the cam follower member of the third transmission member follows an active portion of the guide groove, and so that, when the cam follower member of the first transmission member follows an inactive portion of the guide groove, the cam follower member of the third transmission member follows an inactive portion of the guide groove.

The third transmission member is for example a lever mounted to move in rotation.

According to one embodiment, the first animation member represents the bottom of the body of a first person, the second animation member represents the top of the body of the first person, the third animation member represents the bottom of the body of a second person and the fourth animation member represents the top of the body of the second person, the animation mechanism being configured so that, during an animation cycle corresponding to a rotation of the cam by a half-turn from a starting position, the first and second people thus effect the following successive movements:
the bottom of their bodies and the top of their bodies together carry out a translational movement towards each other;
the top of their bodies pivots relative to the bottom of their bodies which remains immobile, so that their heads approach each other;
the top of their bodies pivots in the reverse direction while the bottom of their bodies still remains immobile;
the bottom of their bodies and the top of their bodies together carry out a translational movement so as to move apart from each other and to return to the starting position.

The position of the cam follower member, for example of the second transmission member, is preferably adjustable in order to adjust the relative position of the second transmission member with respect to the axis of rotation of the cam.

This makes it possible for example to adjust the position of the second animation member with respect to the fourth animation member.

The aim stated above and other advantages are also achieved by virtue of a timepiece comprising such an animation mechanism.

The present invention will be better understood upon reading the following description which is illustrated in the figures, where:

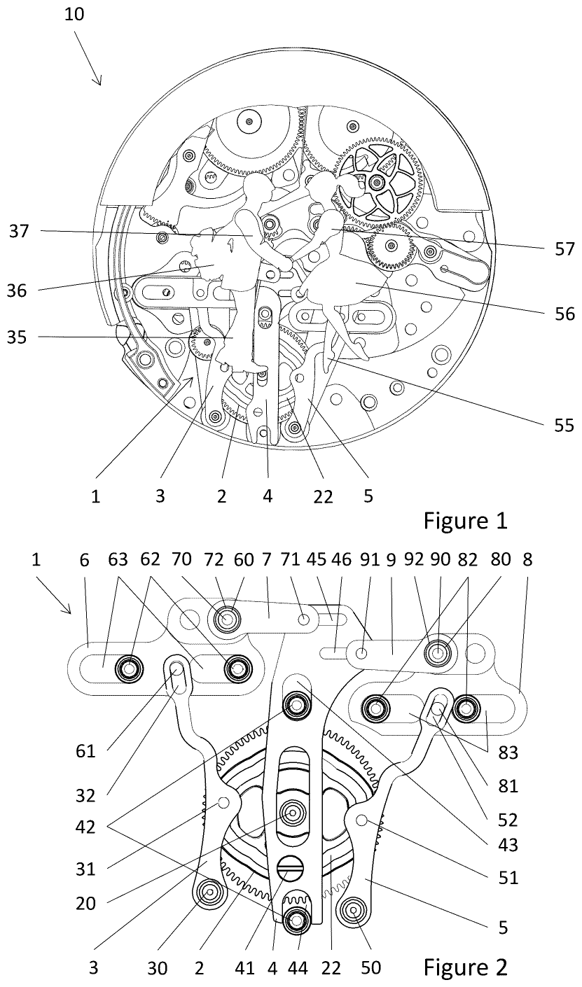

FIG. 1 at least partially illustrates a timepiece comprising an animation mechanism in accordance with one embodiment of the invention;

FIG. 2 shows the animation mechanism inside the timepiece of FIG. 1, without the animation members;

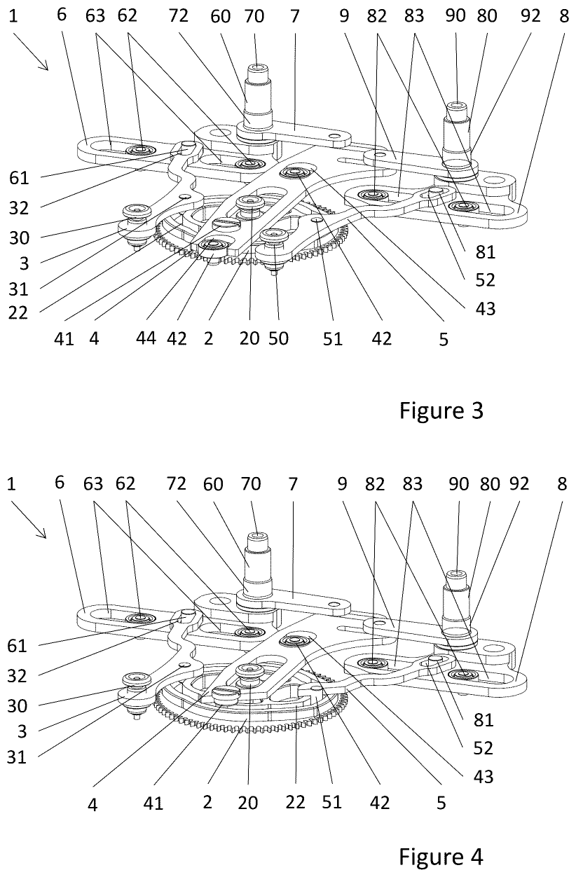

FIG. 3 is a perspective view of the animation mechanism of FIG. 2;

FIG. 4 is a perspective and partial cross-sectional view of the animation mechanism of FIG. 2;

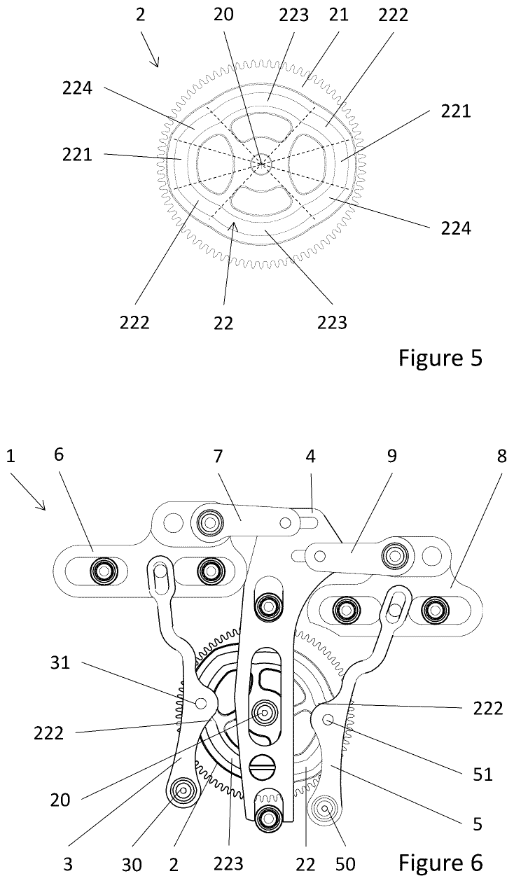

FIG. 5 illustrates the cam of the animation mechanism of FIG. 2;

FIGS. 6 to 12 illustrate different steps of an animation cycle of the animation mechanism of FIG. 2.

According to the embodiment illustrated by the figures by way of illustrative but non-limiting example, the animation mechanism 1 of the invention is intended to be integrated into a timepiece, in particular into a wristwatch 10 partially illustrated in FIG. 1, and is configured to animate animation members 35, 36, 55, 56, 37, 57 forming two people holding hands, for example a male person on the left and a female person on the right, located on the two sides of the centre of the timepiece.

The male person is essentially formed by a first animation member 35 representing the legs of the male person and by a second animation member 36 representing the top of the body (chest and head). The female person is essentially formed by a third animation member 55 representing a first leg on which the female person appears to be standing and by a fourth animation member 56 representing the top of the body (chest, head) and the second leg of the person. Two additional animation members 37, 57 each represent an arm of one of the two people. The arms are mounted to move in rotation at one end at the top of the body of the respective person and they are attached to each other, also so as to move in rotation, at the other end so as to give the impression that the people are holding hands.

According to the embodiment illustrated by way of example, the animation mechanism 1 of the invention is configured so that, during the animation of the animation members 35, 36, 55, 56, the people approach each other, lean forward as if to kiss each other, then return to their starting position illustrated in FIG. 1, all while holding each other by the hand. During an animation cycle, the people thus effect the following successive movements:
the bottom of their bodies 35; 55 and the top of their bodies 36; 56 together carry out a translational movement towards the centre of the timepiece;
the top of their bodies 36; 56 pivots relative to the bottom of their bodies 35; 55 which remains immobile, so that their heads approach each other;
the top of their bodies 36; 56 pivots in the reverse direction while the bottom of their bodies 35; 55 still remains immobile;
the bottom of their bodies 35; 55 and the top of their bodies 36; 56 together carry out a translational movement so as to move away from the centre of the timepiece and to return to the starting position.

The animation mechanism 1 is for example arranged to trigger the animation at moments determined by the movement of the timepiece 10 and/or when requested via a control member not shown in the figures, which the user can actuate. The integration of the animation mechanism 1 into the timepiece 10 is effected in a manner which is known per se and will thus not be described in detail hereinunder. In the timepiece 10, the animation mechanism 1 is associated with a drive member which transmits to the animation mechanism 1 the power required to cause the animation members 35, 36, 55, 56 to move. The drive member is for example a drive member dedicated uniquely to the animation mechanism 1 and rechargeable for example during the actuation of the control member of the animation mechanism and/or the drive member of the movement of the timepiece which is coupled to the animation mechanism for example at moments determined by the movement of the timepiece. As explained in more detail hereinunder, the animation of the animation members 35, 36, 55, 56 is effected by virtue of a cam 2 which is caused to rotate by the drive member and which actuates three transmission members 3, 4, 5 which are kinematically connected to the animation members 35, 36, 55, 56.

FIGS. 2 to 4 illustrate in more detail the animation mechanism 1 of the invention according to the embodiment illustrated in FIG. 1, without the animation members forming the people. The animation mechanism 1 comprises the cam 2 and the three transmission members 3, 4, 5, Each transmission member 3, 4, 5 comprises a cam follower member 31, 41, 51 configured to be inserted in a guide groove 22 of the cam 2 extending around the axis of rotation 20 of the cam 2, the guide groove 22 forming for example a closed curve around the axis of rotation 20 of the cam 2. The cam follower members 31, 41, 51 are preferably pins each fixedly attached to their respective transmission member 3, 4, 5 and inserted in the guide groove 22 (FIG. 4). The pins 31, 41, 51 are preferably formed in a known manner, for example as a single piece or produced from the same piece of material as their respective transmission member 3, 4, 5, or are fixed, for example driven or welded, onto their respective transmission member 3, 4, 5.

In accordance with the illustrated embodiment, the first transmission member 3 is a lever pivoted at one of its ends about an axis of rotation 30. The other end of the lever 3 is kinematically connected to a first carriage 6 mounted to move in translation. The pin 31 of the lever 3 is located between the two ends. The animation mechanism 1 is configured so that the rotation of the lever 3 causes the translation of the first carriage 6. The lever 3 and the first carriage 6 are for example kinematically connected to each other by a pin of one piece inserted in a slot of the other piece. A pin 61 of the first carriage 6 is for example inserted in a slot 32 of the lever 3. The first carriage 6 is for example mounted to move in translation with the aid of fixed elements, for example with the aid of two fixed roller bearings 62, each inserted in a slot 63 of the first carriage 6, the two slots 63 being orientated in the same direction, for example horizontally with respect to the scene formed by the people.

The first carriage 6 comprises a first arm 7 mounted to move in rotation on the first carriage 6, and of which the distal end is kinematically connected to the second transmission member 4. The second transmission member 4 is a bar mounted to move in translation and the animation mechanism 1 is configured so that the translation of the bar 4 causes the rotation of the first arm 7 about its axis of rotation 70. The bar 4 is for example mounted to move in translation with the aid of fixed elements, for example with the aid of two fixed roller bearings 42 inserted in a slot 43 and in a notch 44 in the bar 4. The slot 43 and the notch 44 are orientated in the same direction, for example vertically with respect to the scene formed by the people. However, within the scope of the invention, other forms of mechanisms can be used to mount the second transmission member 4 to move in translation. The first arm 7 and the bar 4 are for example kinematically connected to each other by a pin of one piece inserted in a slot of the other piece. A pin 71 of the first arm 7 is for example inserted in a slot 45 of the bar 4. The slot 45 of the bar 4 is orientated parallel to the direction of translation of the first carriage 6, for example horizontally with respect to the scene formed by the people, so that when the first carriage 6 moves in translation under the effect of the movement of the first transmission member 3 and the second transmission member 4 is immobile, the first arm 7 does not pivot with respect to the first carriage 6.

The first carriage 6 comprises at least one fixing element for fixing on the first carriage 6 of the first animation member 35 (shown in FIG. 1) representing the legs of the male person, for example a pipe 60 fixedly attached to the first carriage 6 disposed around the axis of rotation 70 of the first arm 7. The first arm 7 comprises at least one fixing element for fixing on the first arm 7 of the second animation member 36 (shown in FIG. 1) representing the chest and the head of the male person, for example a pipe 72 fixedly attached to the first arm 7 disposed around the axis of rotation 70 of the first arm 7. In accordance with the invention, the first animation member is fixed on the first carriage 6, for example on the pipe 60 fixedly attached to the first carriage 6, while the second animation member is fixed on the first arm 7, for example on the pipe 72 fixedly attached to the first arm 7, thus kinematically connecting the second animation member to the first animation member. In particular, the second animation member is mounted to move in rotation with respect to the first animation member by means of the first arm 7 which is mounted to move in rotation with respect to the first carriage 6. When the carriage 6 is moved in translation under the effect of the first transmission member 3, the first and the second animation members 35, 36 thus move together in translation. When the first arm 7 is caused to rotate under the effect of the second transmission member 4, the second animation member 36 is caused to rotate and pivots with respect to the first animation member 35. However, other fixing elements can be used within the scope of the invention for fixing the first and second animation members 35, 36 to the first carriage 6 and/or to the first arm 7.

The guide groove 22 of the cam 2 is for example configured to successively move the first transmission member 3 and the second transmission member 4, thus permitting a succession of translational movements of the person and of pivoting movements of the top of his/her body. However, depending on the desired scenography, simultaneous displacements of the first and second transmission members 3, 4 can be used in order to obtain combined movements of the animation members.

With reference to FIG. 5, the guide groove 22 comprises for example at least one active portion 222, 224 and at least one inactive portion 221, 223. In an active portion 222, 224, the distance from the guide groove 22 to the axis of rotation 20 of the cam 2 varies, which causes the displacement of any transmission member with its cam follower member located in such an active portion 222, 224 when the cam is in rotation. In an inactive portion 221, 223, the distance from the guide groove to the axis of rotation 20 of the cam 2 is constant so that any transmission member with its cam follower member located in such an inactive portion 221, 223 when the cam 2 is in rotation remains substantially immobile. According to the illustrated embodiment, the relative positions in the guide groove 22 of the pin 31 of the first transmission member 3 and of the pin 41 of the second transmission member 4 are for example selected so that these pins 31, 41 are practically never simultaneously in an active portion 222, 224 of the guide groove 22.

According to the illustrated embodiment, the animation mechanism comprises three transmission members 3, 4, 5. The third transmission member 5 is preferably arranged in a similar manner to the first transmission member 3. The third transmission member 5 is for example a lever pivoted at one of its ends around an axis of rotation 50. The other end of the lever is kinematically connected to a second carriage 8 mounted to move in translation. The pin 51 of the lever 5 is positioned between the two ends. The animation mechanism 1 is configured so that the rotation of the lever 5 causes the translation of the second carriage 8. The lever 5 and the second carriage 8 are for example kinematically connected by a pin of a first piece inserted in a slot of the other piece. A pin 81 of the second carriage 8 is for example inserted in a slot 52 of the lever 5. The translational path of the second carriage 8 is preferably guided by fixed elements for example by two fixed roller bearings 82, each inserted in a slot 83 of the second carriage 8, the two slots 83 being orientated in the same direction, for example horizontally with respect to the scene formed by the people.

The second carriage 8 comprises a second arm 9 mounted to move in rotation on the second carriage 8, and of which the distal end is kinematically connected to the second transmission member 4. The animation mechanism 1 is configured so that the translation of the second transmission member 4 causes the rotation of the second arm 9 around its axis of rotation. The second arm 9 and the bar 4 are for example kinematically connected to each other by a pin of one piece inserted in a slot of the other piece. A pin 91 of the second arm 9 is for example inserted in a slot 46 of the bar 4. The slot 46 of the bar 4 is orientated parallel to the direction of translation of the second carriage 8, for example horizontally with respect to the scene formed by the people, so that when the second carriage 8 moves in translation under the effect of the movement of the third transmission member 5 and the second transmission member 4 is immobile, the second arm 9 does not pivot with respect to the second carriage 8.

The second carriage 8 comprises at least one fixing element for fixing on the second carriage 8 of the third animation member 55 (shown in FIG. 1) representing the leg on which the female person is standing, for example a pipe 80 fixedly attached to the second carriage 8 disposed around the axis of rotation 90 of the second arm 9. The second arm 9 comprises at least one fixing element for fixing on the second arm 9 of the fourth animation member 56 (shown in FIG. 1) representing the body of the female person, for example a pipe 92 disposed around the axis of rotation 90 of the second arm 9. In accordance with the invention, the third animation member 55 is fixed on the second carriage 8, for example on the pipe 80 fixedly attached to the second carriage 8, while the fourth animation member is fixed on the second arm 9, for example on the pipe 92 fixedly attached to the second arm 9, thus kinematically connecting the fourth animation member to the third animation member. In particular, the fourth animation member is mounted to move in rotation with respect to the third animation member by means of the second arm 9 which is mounted to move in rotation on the second carriage 8. Thus, when the second carriage 8 is moved in translation under the effect of the third transmission member 5, the third and the fourth animation members 55, 56 move together in translation. When the second arm 9 is caused to rotate under the effect of the second transmission member 4, the fourth animation member 56 is caused to rotate and pivots with respect to the third animation member 55. However, other fixing elements can be used within the scope of the invention for fixing the third and fourth animation members 55, 56 to the second carriage 8 and/or to the second arm 9.

In a preferred manner, the position of at least one follower member of one of the transmission members is adjustable so as to be able to adjust the position of the transmission member or members in question relative to the other transmission members, and thus to be able to adjust the position of at least one animation member with respect to the other animation members. According to the illustrated embodiment, the position of the cam follower member 41 of the second transmission member 4 along the longitudinal axis of the second transmission member 4 is adjustable. The cam follower member 41 is for example an eccentric, one end of which is a pin intended to be inserted in the guide groove 22 and the other end serves for pivoting of the eccentric in order to adjust the position of the pin along the second transmission member 4. The rotation of the eccentric by one fraction of a turn makes it possible to adjust the position of the pin along the second transmission member and consequently the position of the second transmission member 4 with respect to the axis of rotation of the cam 2 and with respect to the other transmission members 3, 5. The adjustment of the position of the corresponding cam follower member or cam follower members makes it possible to adjust the relative position of the animation members in order for example to compensate for errors in positioning and/or manufacturing clearances of the animation members and/or during maintenance operations in order to compensate for possible misalignments which have occurred over time.

According to the embodiment illustrated in the figures, the cam 2 comprises four active portions 222, 224 and four inactive portions 221, 223 disposed in an alternating manner around the axis of rotation 20 of the cam 2. The active portions 222, 224 and inactive portions 221, 223 and the transmission members 3, 4, 5 are disposed so that when the pins 31, 51 of the first and third transmission members 3, 5 are located in an active portion 222, 224 of the cam groove 22, the pin 41 of the second transmission member 4 is located in an inactive portion 223 of the cam groove 22, and that when the pin 41 of the second transmission member 4 is located in an active portion 222, 224 of the cam groove 22, the pins 31, 51 of the first and third transmission members 3, 5 are located in an inactive portion 223 of the cam groove 22. Thus when the cam 2 is in rotation, the people move either by translation or by pivoting of the top of their body.

The active portions 222, 224 and inactive portions 221, 223 are for example dispersed in such a way that the guide groove 22 is continuous and comprises for example a sequence 221, 222, 223, 224 of active and/or inactive portions which is repeated at least once over the whole circumference of the guide groove 22. In the anti-clockwise direction, the guide groove 22 comprises successively for example over one half-turn:
a high inactive portion 221 in which the distance from the guide groove 22 to the axis of rotation 20 is constant and maximal;
a decreasing active portion 222 in which the distance from the guide groove 22 to the axis of rotation 20 decreases in the anti-clockwise direction;
a low inactive portion 223 in which the distance from the guide groove 22 to the axis of rotation 20 is constant and minimal;
an increasing active portion 224 in which the distance from the guide groove 22 to the axis of rotation 20 increases in the anti-clockwise direction.

The above-mentioned sequence of four portions 221, 222, 223, 224 is then repeated on the other half of the guide groove 22.

FIGS. 6 to 12 illustrate a number of successive momentary positions of the animation mechanism 1 during an animation cycle, with the animation members omitted for the sake of clarity.

The cam 2 is mounted for conjoint rotation with a toothed wheel 21 which makes it possible for it to be driven by a going train driven by the drive member. The cam 2 and the toothed wheel 21 are for example a single monobloc piece. The animation mechanism 1 is driven so that the cam 2 turns in the clockwise direction. The pins 31, 41, 51 thus run through the guide groove 22 in the anti-clockwise direction.

FIG. 6 shows the animation mechanism 1 just after the start of the rotation of the cam 2 from the inoperative position illustrated in FIG. 2. In this position, the pins 31, 51 of the first and third transmission members 3, 5 each enter into a decreasing active part 222 of the cam groove 22 which brings them closer to the axis of rotation 20 of the cam 2. The first transmission member 3 thus initiates a rotational movement for example in the clockwise direction, while the second transmission member 5 initiates a rotational movement in the anti-clockwise direction. The rotation of the first and third transmission members 3, 5 drives the horizontal translation of the first and second carriages 6, 8 towards one another. The pin 41 of the second transmission member 4 is, for its part, located in a low inactive portion 223 of the cam groove 22 so that the second transmission member 4 remains immobile. The people are thus moved towards one another without the top of their body 36, 56 pivoting with respect to the bottom 35, 55.

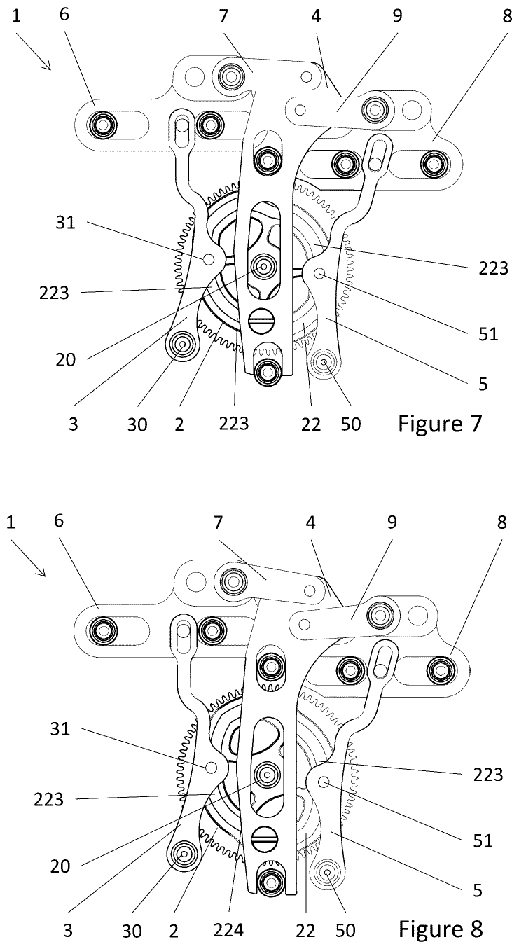

In the position illustrated in FIG. 7, the pins 31, 51 of the first and third transmission members 3, 5 are each at the end of the respective decreasing active portion 222. The first and third transmission members 3, 5 are thus at the end of their rotational movement towards the centre of the animation mechanism 1, and the first and second carriages 6, 8 are as close as possible to each other. The pin 41 of the second transmission member 4 is at the end of the low inactive portion 223, in which it has been located since the start of the animation cycle. The second transmission member 4 is thus still in its initial position. The people are thus at their closest facing each other in an upright position.

In the position illustrated in FIG. 8, the pins 31, 51 of the first and third transmission members 3, 5 are each located in a low inactive portion 223 of the cam groove 22, while the cam follower member 41 of the second transmission member 4 is located in an increasing active portion 224 which tends to move it away from the axis of rotation, which has the effect, according to the illustrated configuration of the animation mechanism 1, of moving the second transmission member 4 downwards in translation with respect to the scene represented by the animated people. In its downwards movement, the second transmission member 4 drives the pins 71, 91 of the first and second arms 7, 9 of the first and second carriages 6, 8 which are inserted in the slots 45, 46 shown for example in FIG. 2. The driving of the pins 71, 91 causes the pivoting of the first and second arms 7, 9 so that the chests of the people lean towards each other.

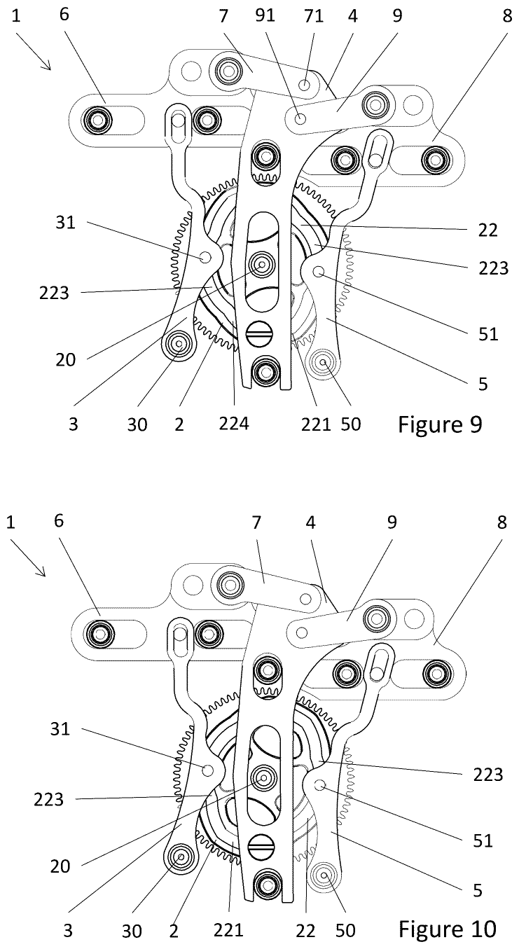

In the position illustrated in FIG. 9, the pins 31, 51 of the first and third transmission members 3, 5 are still in the same low inactive portion 223, while the pin 41 of the second transmission member 4 is at the end of the increasing active portion 224 and is ready to enter a high inactive portion 221. The pin 41 of the second transmission member 4 is in its position furthest away from the axis of rotation 20 of the cam 2. The second transmission member 4 is thus in its lowest position and the top of the body 36, 56 of the people is leaning forward, their heads just touching as if to kiss each other.

According to the illustrated embodiment, and as explained above, the relative position of the second transmission member 4 with respect to the axis of rotation of the cam 2 can be adjusted. In a preferred manner, the vertical position of the second transmission member 4 is adjusted so that, in its lowest position, the second and fourth animation members representing the heads of the people are exactly on a level with each other. The adjustment is preferably effected following assembly of the animation mechanism 1, for example to compensate for errors in positioning and/or manufacturing of the animation members and/or during maintenance operations in order to compensate for possible misalignments which have occurred over time.

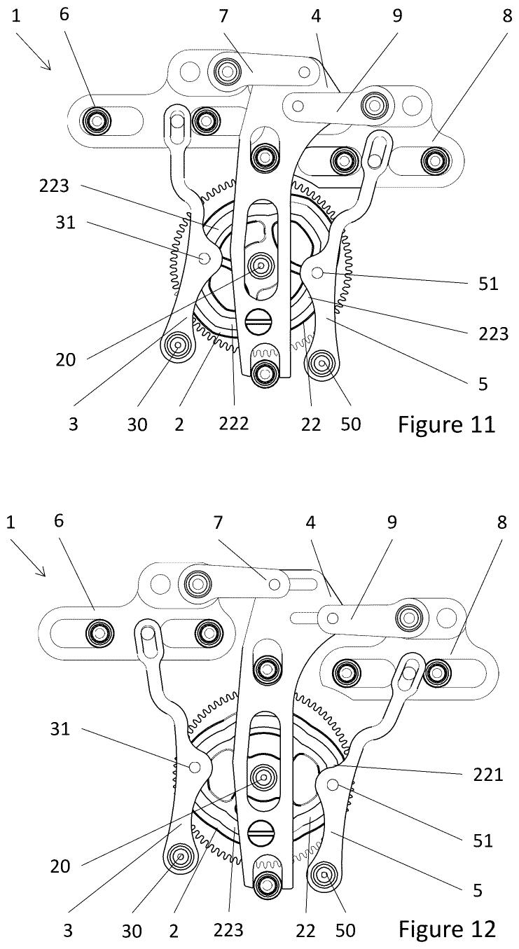

In the position illustrated in FIG. 10, the pin 41 of the second transmission member 4 is at the end of the high inactive portion 221 while the pins 31, 51 of the first and third transmission members 3, 5 are still located in the same low inactive portion 223 as before. Between the position illustrated in FIG. 9 and that illustrated in FIG. 10, which, in the illustrated embodiment, corresponds to a rotation of about 30° of the cam 2, the people have thus remained immobile in the kissing position. Subsequent to this position, the cam 2 continuing its rotation, the pin 41 of the second transmission member 4 enters a decreasing active portion 222 which will guide it in the direction of the axis of rotation 20 of the cam 2. The second transmission member 4 is thus moved upwards, causing the first and second arms 7, 9 of the first and second carriages 6, 8 to pivot so as to return the tops of the bodies 36, 56 of the people to their straightened-up position, in the position illustrated in FIG. 11. During this rotation of the cam 2, the pins 31, 51 of the first and third transmission members 3, 5 remain in the inactive portion 223. The bottoms of the bodies 35, 55 of the animated people thus remain immobile while they straighten up.

In the position illustrated in FIG. 11, the pin 41 of the second transmission member 4 leaves the decreasing active portion 222 in order to enter a low inactive portion 223, while the pins 31, 51 of the first and third transmission members 3, 5 each leave a low inactive portion 223 in order to enter an increasing active portion 224, while the cam 2 continues its rotation. The second transmission member 4 is thus immobilised, while the pins 31, 51 of the first and third transmission members 3, 5 are moved away from the axis of rotation 20 of the cam 2 by the guide profile 22. The first and second carriages 6, 8 are moved under the effect of the rotation of the first and third transmission members 3, 5 towards the outside of the animation mechanism 1. The people are thus moved away from each other to return to their starting position.

At the end of an animation cycle, the animation mechanism 1 is again located in the position illustrated in FIG. 12. According to the illustrated embodiment, the cam 2 effects one half-turn per animation cycle. In the position illustrated in FIG. 12, all the pins 31, 41, 51 are again located in an inactive portion 221, 223 of the guide groove 22. One advantage of such a configuration is that the position of the people at the end of a cycle will always be identical even if the angular position of the cam 2 at the end of the cycle is not always exactly the same.

During the next animation cycle, the cam 2 will again effect one half-turn on itself, which, by reason of the repetition of the sequence 221, 222, 223, 224 of the active and inactive portions of the guide profile 22, will animate the animation mechanism 1 in the same way as indicated above.

Other embodiments are possible within the scope of the invention. In particular, the length and the number of the active and inactive portions of the guide groove may be different. The number of repetitions of the sequence of active and/or inactive portions on the circumference of the guide groove may also be different, for example two, three or four, depending for example on the amplitude of the rotation of the cam during an animation cycle and/or on the number of guided transmission members. However, it is conceivable within the scope of the invention that the guide groove does not comprise a sequence repetition, the cam then effecting for example one full turn per animation cycle. It is also conceivable within the scope of the invention that the guide groove does not comprise an inactive portion, all the transmission members being moved simultaneously once the cam is in motion.

In the illustrated embodiment, the animation mechanism 1 comprises three transmission members 3, 4, 5, including two levers 3, 5 and a bar 4 caused to move by the same guide groove 22 of the cam 2. However, the number and type of transmission member can be selected differently within the scope of the invention, at least two transmission members being caused to move by the same guide groove. The follower members of the at least two transmission members being inserted at different positions in the guide groove, these at least two transmission members are guided along the same curve formed by the guide groove but in an out-of-phase manner.

In the illustrated embodiment, the transmission members moved in rotation by the cam generate linear movements of the animation members, while the transmission member moved in translation by the cam generates rotational movements of the animation members. However, other combinations of movements are possible within the scope of the invention depending on the requirements of the animation and/or of the display guided by the cam. Within the scope of the invention, it is possible for transmission members moved in rotation by the cam to generate movements of animation members in rotation and/or in translation, and/or for transmission members moved in translation by the cam to generate movements of animation members in translation and/or in rotation.

1. Animation mechanism (1) comprising:
a cam (2) mounted to move in rotation around an axis of rotation (20) of the cam (2), the cam (2) comprising a guide groove (22),
a first animation member (35) kinematically connected to the cam (2) by a first transmission member (3),
a second animation member (36) kinematically connected to the cam (2) by a second transmission member (4),
the first transmission member (3) and the second transmission member (4) each comprising a cam follower member (31, 41) intended to cooperate with the guide groove (22).

2. Animation mechanism (1) as claimed in claim 1, wherein the second animation member (36) is kinematically connected to the first animation member (35).

3. Animation mechanism (1) as claimed in claim 1, wherein the second animation member (36) is mounted to move in rotation with respect to the first animation member (35).

4. Animation mechanism (1) as claimed in claim 1, comprising a first carriage (6) and a first arm (7) mounted to move in rotation on the first carriage (6), the first carriage (6) being kinematically connected to the first transmission member (3) and the first arm (7) being kinematically connected to the second transmission member (4), the first animation member (35) being fixed on the first carriage (6) and the second animation member (36) being fixed on the first arm (7).

5. Animation mechanism (1) as claimed in claim 4, wherein the first carriage (6) is mounted to move in translation.

6. Animation mechanism (1) as claimed in claim 1, wherein the guide groove (22) is arranged around the axis of rotation (20) of the cam (2) and wherein said cam follower member (31, 41) is inserted in the guide groove.

7. Animation mechanism (1) as claimed in claim 6, wherein the guide groove (22) forms a closed curve.

8. Animation mechanism (1) as claimed in claim 1, wherein the first transmission member (3) is a lever mounted to move in rotation and the second transmission member (4) is a bar mounted to move in translation.

9. Animation mechanism (1) as claimed in claim 1, wherein the guide groove (22) comprises at least one active portion (222, 224) in which the distance from the guide groove (22) to the axis of rotation (20) of the cam (2) is variable and at least one inactive portion (221, 223) in which the distance from the guide groove (22) to the axis of rotation (20) of the cam (2) is constant,
the animation mechanism (1) being configured so that, when the cam follower member (31) of the first transmission member (3) follows an active portion (222, 224) of the guide groove (22), the cam follower member (41) of the second transmission member (4) follows an inactive portion (223) of the guide groove (22), and so that, when the cam follower member (41) of the second transmission member (4) follows an active portion (222, 224) of the guide groove (22), the cam follower member (31) of the first transmission member (3) follows an inactive portion (223) of the guide groove (22).

10. Animation mechanism (1) as claimed in claim 1, further comprising a third animation member (55), a fourth animation member (56) and a third transmission member (5), the third animation member (55) being kinematically connected to the cam (2) by the third transmission member (5) and the fourth animation member (56) being connected to the cam (2) by the second transmission member (4), the third transmission member (5) comprising a cam follower member (51) inserted in the guide groove (22).

11. Animation mechanism (1) as claimed in claim 1, configured so that, when the cam follower member (31) of the first transmission member (3) follows an active portion (222, 224) of the guide groove (22), the cam follower member (51) of the third transmission member (5) follows an active portion (222, 224) of the guide groove (22), and so that, when the cam follower member (31) of the first transmission member (3) follows an inactive portion (221, 223) of the guide groove (22), the cam follower member (51) of the third transmission member (5) follows an inactive portion (221, 223) of the guide groove (22).

12. Animation mechanism (1) as claimed in claim 10, wherein the third transmission member (5) is a lever mounted to move in rotation.

13. Animation mechanism (1) as claimed in claim 10, wherein the first animation member (35) represents the bottom of the body of a first person, the second animation member (36) represents the top of the body of the first person, the third animation member (55) represents the bottom of the body of a second person and the fourth animation member (56) represents the top of the body of the second person, the animation mechanism (1) being configured so that, during an animation cycle corresponding to a rotation of the cam (2) by one half-turn from a starting position, the first and second people thus effect the following successive movements:
the bottom of their bodies (35; 55) and the top of their bodies (36; 56) together carry out a translational movement towards each other;
the top of their bodies (36; 56) pivots relative to the bottom of their bodies (35; 55) which remains immobile, so that their heads approach each other;
the top of their bodies (36; 56) pivots in the reverse direction, while the bottom of their bodies (35; 55) still remains immobile;
the bottom of their bodies (35; 55) and the top of their bodies (36; 56) together carry out a translational movement so as to move apart from each other and to return to the starting position.

14. Animation mechanism (1) as claimed in claim 1, wherein the position of the cam follower member (41) of the second transmission member (4) is adjustable in order to adjust the relative position of the second transmission member (4) with respect to the axis of rotation (20) of the cam (2).

15. Timepiece (10) comprising an animation mechanism (1) as claimed in claim 1.
